(19) United States
(12) Patent Application Publication
(10) Pub. No.: US 2008/0110009 A1
(43) Pub. Date: May 15, 2008

(54) METHOD FOR SHAPING A WORK PIECE AND SHAPING DEVICE

(75) Inventors: Stelios Katsibardis, Coburg (DE); Kai Spath, Coburg (DE)

Correspondence Address: Schwegman, Lundberg, Woessner & Kluth, P.A., P.O. Box 2938, Minneapolis, MN, 55402, US

(73) Assignee: Langenstein & Schemann GmbH

(21) Appl. No.: 11/927,417

(22) Filed: Oct. 29, 2007

Related U.S. Application Data
(63) Continuation of application No. 11/335,109, filed on Jan. 19, 2006, now abandoned.
Application No. 11/335,109 is a continuation of application No. PCT/EP2004/006502, filed on Jun. 17, 2004.

(30) Foreign Application Priority Data
Jul. 19, 2003 (DE) DE 103 32 888.2

(51) Int. Cl. B23P 17/00

(52) U.S. Cl. 29/421.1

(57) ABSTRACT

The invention relates to a method for shaping at least one work piece and to a shaping device, especially for use in said method or for carrying out said method. Said shaping device comprises at least one support (3) for a work piece (4), at least one striking tool, at least one drive device (2) for moving said striking tool relative to the support (3) and at least one position sensing device for determining the position of the striking tool. For shaping the work piece (4), an initial position of the striking tool can be adjusted. A control and regulation device controls and regulates the velocity of the striking tool during a striking motion. According to the method of the invention, the striking tool, during a striking motion from a defined or definable initial position, impacts the work piece (4) present on the support (3) with a defined or definable impact velocity. The velocity of the striking tool during the striking motion is controlled or regulated subject to the position of the striking tool and subject to the defined impact velocity.

### RELATED APPLICATIONS

This application is a continuation of U.S. patent application Ser. No. 11/335,109, filed Jan. 19, 2006, which application is a continuation under 35 U.S.C. 111(a) of PCT/EP2004/006502, filed on Jun. 17, 2004, and published on Mar. 3, 2005 as WO 2005/018850A1, which claims the benefit under 35 U.S.C. 119 of German Application No. DE 103 32 888.2, filed Jul. 19, 2003, which applications and publication are incorporated herein by reference.

### DESCRIPTION

The invention relates to a method for the shaping of a workpiece as well as a shaping device, particularly for its use in the method or for the execution of the method.

Numerous methods and devices are available for the shaping of workpieces. The workpieces are brought into contact with suitable tools in pressing machines which provide the power necessary for the process. The pressing machines differ from each other by virtue of and working bound pressing machines generally. In connection with this, of special interest are the working bound shaping devices or pressing machines, particularly the spindle press. The defining characteristic of the work-bound pressing machines is the work capacity E, which is converted completely at every operation.

In a spindle press, the spindles are driven by a form- or friction-bound flywheel or also by direct motor drive. The rotation is converted about a steep common multiple thread in a straight ram movement. When the striking the workpiece with the ram, the kinetic energy from the flywheel, spindle and ram is converted completely into useful and lost work. The conversion of energy is indicated by the striking effectiveness, tjs. (Lexikon Produktionstechnik Verfahrenstechnik, Hrsg. Heinz M. Hiersig, VDI-Verlag).

As a rule, the drive for the spindle, e.g., the flywheel is set in motion with an electrical drive motor, preferably an asynchronous motor. In order to achieve optimal operating response, i.e. drive performance, current consumption, degree of effectiveness, flexible ranges of application, and short piston stroke times, it is desirable to correspondingly control and to regulate the spindle press, e.g., the ram piston stroke.

In the printed publication DE 34 44 240 C2 a spindle press is disclosed, with which the rotational speed with a ram is widely adjustable and also shaping work therefore can be carried out with a relatively low work capacity like e.g. edge upsetting. The spindle press contains a flywheel connected to a drive, which shows an initial speed at the beginning of the ram stroke, which is connected to the spindle over a disc clutch with the driving pulley and which approximately comes to a standstill and is disconnected from the spindle at the end of the shaping process. The spindle with the spindle driving pulley also has a drive of its own which at the same time also serves for the return stroke of the ram. For the working stroke, the spindle is accelerated by way of the spindle drive, preferably maximally, and then regulated downwardly for the speed required for the clutch with the flywheel at the end of the empty piston stroke.

If the largest portion of the ram piston stroke will have obtained a higher speed with a split clutch as disclosed in DE 34 44 240 for the spindle press for itself, the process is achieved by short stroke times. In any event, it is necessary to have two high-performance drive motors with this form of carrying out the process, which can lead to a high current demand. If the speeds are not regulated with exactness, energy can be lost by the clutch process.

Printed publication DE 38 41 852 A1 describes a drive layout for driving a threaded spindle of a spindle press, that is accomplished with the coupling of a threaded spindle to a driving pulley permanently rotating about a differential with respect to an overlapping transmission. For the interlink, movement of the transmission is braked. By corresponding control and regulation of the deceleration, speed and torque and therewith the pressing strength and piston stroke speed can be varied during the cycle. Moreover, the braking energy can be released, for example and used for the return stroke of the ram.

It is the disadvantage of this construction that a permanently rotating driving pulley is necessary, which leads to a higher energy consumption. A further disadvantage is the large speed difference between spindle and driving pulley at the coupling, which results in energy consumption and clutch wear.

A directly driven spindle press is disclosed in DE 195 45 004 A1. Here, an optimal operating response is reached by it for the improvement in the energy balance and for a more exact regulation of the way-time path a variable-speed drive is used consisting of a three-phase current asynchronous motor and a frequency setting or transformer. The required shaping energy is adapted by variation of the speed. The velocity-time path of the spindle can be varied by facilities for the control or regulation of the drive.

By variation of the velocity-time path, relatively short piston stroke times can be realized for reaching the respectively desired shaping energy. Tolerances caused by the mechanics remain though, for example at the return piston stroke of the ram or unconsidered tolerances in the workpieces, which on the one hand, have an effect on the precision of the shaping process and on the other hand can lead to an energy loss also.

Another directly driven spindle press is depicted on the internet page: Lasco-Fimrenzeitschrift “upgrade” (Edition: December 2000). As an example a shaping procedure is shown with lesser shaping energy. The drive engine with frequency converter accelerates the movable structures, that is flywheel and spindle coupled therewith, corresponding to the maximum energy of a corresponding rotational speed. The ram is driven downwards with maximum speed until shortly before the beginning of the shaping process, and then slowed with the pre-selected speed to begin the shaping process. The reverse stroke is made by reversing the drive. Approximately halfway during the reverse stroke, braking reoccurs and the drive elements are so delayed such that the mechanical brake works as a park brake merely in the upper dead-motion point.

Relatively short piston stroke times can be realized as in the case of the spindle press revealed in DE 195 45 004 A1 for reaching the respectively desired shaping energy in this previously described spindle press. Tolerances caused by the mechanics remain, though, the speed of the ram or the speed of the drive motor and the position of the ram in which they are braked without consideration, there are also firmly predefined for example at the moving piston stroke of the ram or tolerances in the workpieces depending on workpiece.

It is therefore the problem of the invention to provide a method for shaping a workpiece as well as a shaping device particularly for the use in the method or for the execution of the method by which the aforementioned disadvantages in the state of the art are at least partly overcome or at least reduced.

This problem is solved with regard to the method for shaping a workpiece with the features of the patent claim 1 and with regard to the shaping device with the features of the patent claim 28.

With the method according to claim 1 for shaping at least one workpiece, a striking tool impacts a workpiece disposed upon a support during a striking movement from a pre-selected or preselectable initial position and with a preselected or preselectable impact velocity, and the velocity of the striking tool during the striking movement is controlled in open-loop or closed-loop dependent upon the position of the striking tool and also dependent upon the pre-selected impact velocity.

The shaping device in accordance with claim 28, particularly for its use in the method or for the execution of method according to claim 1, or according to claim 1, comprises at least one support for a workpiece, at least one striking tool, at least one drive device for moving the striking tool relatively to the support, and at least one position measuring device for determining the position of the striking tool, wherein for the shaping of the workpiece an initial position of the striking tool is settable or is preset and wherein an open loop or closed loop control device is provided that controls the velocity of the striking tool during a striking movement dependent of the position thereof, such that a pre-selected or pre-selectable striking velocity is achieved or reached at the workpiece.

The striking movement is preferably the axial movement of the striking tool (or: ram) in the direction of the workpiece and to be more precise out of an initial position until or to the collision with the workpiece. The height difference which the striking tool passes through during the striking movement from the initial position until or to the impact on the workpiece is the stroke of the striking tool, referred to as working stroke or striking stroke in the following also. As a rule, the striking tool is driven back into a pre-selected end position after the shaping procedure. The height difference that the striking tool moves through during this backward movement is also referred to as the return stroke.

The velocity of the striking tool during the striking movement is a measure for the available kinetic energy (E). The kinetic energy is proportional to the product of the mass (m) of the striking tool and the square of the velocity (v) of the striking tool (E=½ mv²). Since the mass of the striking tool is constant during the striking movement, so primarily the velocity of the striking tool and the initial position, respectively, or the working stroke and the acceleration (dynamic equations) of the striking tool play a decisive role for the kinetic energy which is available at or during the impact. The kinetic energy at or during the impact which results from the impact velocity of the striking tool is described below also as a shaping energy.

Upon the impact on the workpiece, the shaping energy is mostly transformed to useful work, by which the workpiece is deformed. The dissipation energy or the resulting dissipation work is captured among other things in the recoil of the striking tool.

It is therefore a central thought of the invention that the velocity of the striking tool during the striking movement can be controlled in open loop or closed loop dependent upon the position of the striking tool to reach a desired or predefined impact velocity. This means in other words, that the actual speed (v(t)) of the striking tool is a function of the actual position (x(t)) of the striking tool (v(t)=v(x(t)). Therefore, the position (x) of the striking tool is the variable here. The impact velocity of the striking tool is a constant which can, however, be chosen arbitrarily in its value. The striking tool therefore is either accelerated or braked, depending on in which location (or: position) it is located, in order to reach the predefined impact velocity in any event.

The initial position (x(t₀)) of the striking tool can be determined and adjusted depending on the predefined impact velocity, for example if the striking movement shall be carried out with a constant velocity or a constant acceleration or depending on the requirements of the workflow.

Therefore, the method in accordance with the invention has the advantage that a desired impact velocity and the resulting shaping energy, respectively, can be reached within a scope provided by the physical qualities, independently from the adjusted initial position, and that similarly, within certain limits, a desired initial position can be adjusted independent from the preselected impact velocity. Thereby, the shaping process can be used very flexible.

To determine the velocity during the striking movement as a function of the position of the striking tool, at least one position of the striking tool can be measured or determined. With the value of the at least one position of the striking tool and the predefined or preselected impact velocity, the velocity values during the striking movement can then be calculated.

The position of the striking tool is preferably determined with a suitable position measuring device which transmits the position value to an open loop or closed loop control device for the open loop or closed loop control of the striking tool. On the one hand, through this it is possible to determine a certain position, for example the initial position, and, after this, to calculate or compute the course or run of the velocity which is necessary or advantageous and/or optimal to reach the predetermined impact velocity. The striking tool is then controlled in open loop or closed loop during the striking movement toward these velocity values. On the other hand, an open loop or closed loop control also can be carried out in real time by continuously measuring or determining the actual position during the striking movement and by then computing or calculating, preferably by numerical differentiating, the velocity with the measured actual position values and controlling the velocity in open loop or closed loop.

That the position of the striking tool is known according to the invention within the shaping device at any time, has the further advantage that an exact work-repeating process or working with exact repetition is made possible. It is particularly advantageous if, for example by the position measuring device, the initial position of the striking tool and/or the position after a return stroke movement of the striking tool is measured or determined. If then, for example, a too big tolerance should appear at the return stroke movement of the striking tool, i.e. the actual return stroke is greater or less than the predefined height difference, this is detected by the position measuring device and used for the determination of the course, path or run of the velocity of a following working stroke, so that the striking tool hits the workpiece exactly with the predetermined impact velocity again.

With multiple impacts of the striking tool upon the same workpiece, it is advantageous for the position of the striking tool to be determined or measured after the deformation of the workpiece by the impact. Thereby, if a workpiece is subsequently processed in the device, the height changed by the deformation of the workpiece can be determined and the subsequent working stroke can be by way of example, extended by this distance, so that the shaping energy transferred to the workpiece is always constant.

In a particularly advantageous embodiment, the striking tool is accelerated from the initial position to the predefined impact velocity. It can be advantageous in order to achieve or reach an impact velocity that is less than a maximum impact velocity if the initial position is adjusted to be lower than a maximum initial position.

As a rule, the striking tool can pass during its striking movement from a maximum initial position a predetermined maximum working stroke predetermined by the shaping device, after which the largest and/or maximum impact velocity and with that the maximum shaping energy is reached. Due to the ability to determine the position of the striking tool, however, the ram or the striking tool also can be driven from any arbitrary position or location within the maximum working stroke so that a working stroke results which is less than the maximum working stroke. The highest attainable impact velocity or shaping energy is then lower than the maximum impact velocity or shaping energy respectively.

This is particularly advantageous in applications with flat workpieces and/or a low amount of needed shaping energy. When accelerating from the initial position, the desired impact velocity and/or shaping energy is then just reached at the impact on the workpiece. The short working stroke on the one hand entails very short stroke times by what very short cycle times can be obtained, on the other hand energy can be saved through this also.

Furthermore, it is particularly advantageous, if the striking tool is accelerated from the initial position and braked after reaching a pre-selected or predetermined position between the initial position and the workpiece to reach the predetermined impact velocity. Consequently, the velocity is varied over the stroke length in such a way that the generating of low impact velocities or shaping energies is also possible from a high initial position and at with a great working stroke, for example. Yet, in order to reach a short working stroke time, the striking tool is first accelerated to a maximum velocity, if possible with a maximum start-up acceleration, which maximum velocity is reached in the previously determined position between the initial position and the workpiece, from which on the striking tool is braked down to the desired impact velocity, which is lower than the maximum velocity.

In practice, a very high initial position can therefore be chosen when working on the top of very big or long workpieces to facilitate the feeding a the workpiece into the support, for example. Also when using automatic feeding devices for the workpieces, for example robots with grippers or automatic gripping tools, a high initial position of the striking tool can be of advantage to facilitate the feeding. From this high initial position can then, when proceeding in accordance with the invention, depending on the application, both high and low shaping energies can be produced.

Furthermore it is particularly advisable if the velocity of the striking tool during the striking movement is controlled in open loop or closed loop in such a way that at or from an arbitrary initial position the shortest possible working stroke time will be reached. This can be realized using the control device which optimizes the velocity run or course of the striking tool depending on the position and the predefined impact velocity of the striking tool striking tool arithmetically in such a way that, if possible, the shortest stroke time will be reached.

The open loop as well as closed loop control of the velocity of the striking tool is preferably carried out with a control device which controls a drive motor with a variable rotational velocity of a drive device for the striking tool. For the control device, a frequency converter unit is preferably used, which controls the rotational velocity and the direction of rotation of the drive motor. It is particularly advantageous if the frequency converter unit, bay means of a microprocessor, determines the run or course of the rotational velocity of the drive motor during the striking movement, dependent on a predefined impact velocity and a predefined initial position and/or a position determined by means of a position measuring device. In a particularly advantageous embodiment of the method in accordance with the invention, the striking tool is raised or lifted back or returned after the impact by a return stroke movement into a predefined or predefinable end position. The return stroke movement into the end position is carried out preferably at a reversed direction of rotation of the drive motor. However, also other methods are conceivable to bring the striking tool into the end position. For example, the striking tool can get back elevated hydraulically or pneumatically by means of telescope bars. The pressure necessary for this can be achieved, for example, during the striking movement of the ram by pressuring a liquid or a gas in a suitable pressure chamber.

It is particularly advantageous if the velocity of the striking tool during the return stroke movement toward the end position is controlled in open loop or closed loop and regulated dependent on the position of the striking tool. An optimal control of the velocity of the striking tool is given by the frequency converter unit whose microprocessor determines the rotational velocity course or run during the stroke dependent an the predefined end position and/or a position determined by means of the position measuring device. This control possibility can be used at or during the return stroke of the striking tool by means of the drive motor.

It is particularly useful if as an end position of a return stroke, the initial position of the striking tool for the working stroke is chosen. Through this, primarily if several equal workpieces shall be shaped in sequence, the optimal stroke time and shaping energy can always be reached. It is also possible, however, to drive the striking tool to an arbitrary different end position. This can be of advantage if different workpieces shall be processed subsequently. The end position of the return stroke can then particularly be chosen depending on the workpiece to be worked on and/or on the desired impact velocity at the following striking movement.

In a particularly advantageous embodiment, the striking tool is accelerated during the return stroke movement to the end position away from the workpiece or support and, when reaching a pre-selected position between the workpiece or the support on the one hand and the end position on the other hand, braked by the drive motor. When reaching the end position, the striking tool is then braked completely or finally by a mechanical braking device. This control and regulation of the velocity at or during the return stroke movement has the advantage that the striking tool can be driven to the end position very exactly, at the same time, however, reaches this end position very fast. Furthermore the danger is reduced that the mechanical braking device wears out fast or that the overflow and/or the tolerance of the return stroke is too big as it can be the case at too high velocity of the striking tool when reaching the end position.

This exact control of the velocity in the return stroke and/or the exact end position of the striking tool resulting from it is, for example, particularly advisable if the workpiece with the striking tool is driven to the end position and is removed in the end position. The workpiece then can always be removed and placed aside with high precision with the help of a removing device, for example a gripping tool.

In a particularly advantageous embodiment of the method according to the invention, the striking tool during acceleration is accelerated with a predefined constant starting acceleration. Preferably the striking tool is braked also with a predefined constant braking acceleration during braking. Thereby, a high precision and an energy-saving mode of operation are simultaneously achieved. The amount of the constant starting acceleration and the constant braking acceleration can, for example, respectively be chosen depending on the direction of motion of the striking tool, therefore depending on whether it carries out a striking movement or a return stroke movement. The effect of the gravity on the striking tool can then, for example, be taken into account and then the acceleration can be selected correspondingly.

It is particularly advantageous if the drive motor is switched momentumless and/or is disengaged within the driving device just before the impact of the striking tool upon the workpiece. Through this method, loads for the engine or motor and the control device are avoided which can be caused by appearing current and voltage peaks. Normally, the drive motor can be switched momentumless by means of the frequency converter unit. Switching the motor momentumless or disengagement is carried out, for example, on a signal of the position measuring device shortly before the impact so that no shaping energy is lost if possible.

In a particularly advantageous embodiment of the method in accordance with the invention, the drive motor is operated as a generator during braking of the striking tool by means of the drive motor. The energy recovered by the generator during the braking action then can be fed back into the power supply system.

The position of the striking tool in the shaping device is preferably determined by at least one, particularly contactless position detector, particularly by an optical or magnetic or inductive and preferably incremental position detector. It is the advantage of this method that the measuring can be carried out contactless and that the measuring device can therefore be attached to a safe position in the machine.

In an advantageous embodiment of the method in accordance with the invention, a shaping device is used which is constructed as a spindle press and in which the drive motor works in the drive device of the spindle press. The drive motor preferably directly drives a flywheel, which in turn puts a spindle coupled therewith into rotation. The spindle acts in combination with the striking tool, preferably by means of a thread, in such a way that the striking tool is moved by the rotation of the spindle, depending on the direction of rotation, to the workpiece and/or support or away from these.

The shaping device designed particularly for use in the method or for the processing of the method in accordance with the invention comprises at least a support for the workpiece, at least a striking tool, at least a drive device for moving the striking tool relatively to the support, and at least a position-measuring device for determining the position of the striking tool within the shaping device, wherein for shaping the workpiece an initial position of the striking tool can be preset or is preset, and wherein a open loop or closed loop control device is provided, which controls, the velocity of the striking tool during a working strike dependent upon its position, such that a preselected or preselectable impact velocity on the workpiece can be achieved or reached.

The shaping device is preferably a spindle press. However, it is also conceivable to adapt or design the shaping device as another work-bound shaping machine and/or pressing machine, for example a hammer, or as a power-bound pressing machine like a hydraulic press. The shaping devices then essentially differ in the concrete arranging of the driving device. A variety of possible drives can be controlled with suitable means in such a way that the velocity can be varied over the n stroke. By the use of the position measuring device this is then possible also from any arbitrary initial position.

If the shaping device is therefore constructed for the execution of the method according to the invention as a spindle press, then the drive device contains preferably a rotation speed variable drive motor in which particularly an asynchronous machine can be used. Furthermore the drive device contains a flywheel that is coupled with a spindle and is driven by the drive motor.

In a particularly advantageous embodiment of the shaping device, a frequency converter unit which controls the drive motor speed and possibly also the direction of rotation of the drive motor is used as a control device. The frequency converter unit preferably contains a microprocessor. Among other things the desired values for the respective initial position and the speed can be entered into a memory affiliated to the microprocessor. The values determined by the position measuring device are also transmitted as a signal to the microprocessor. From these values, the processor then determines or calculates or computes the necessary or most favorable course or run of rotational velocity during a striking movement.

For the return stroke movement of the striking tool from the work-piece or support, an end position for the striking tool is preferably adjustable or adjusted, moreover. The end position also is stored in the memory affiliated to the microprocessor so that the processor also can calculate the course of the return stroke movement The return stroke movement is carried out preferably by changing the direction of rotation of the drive motor.

It is particularly advantageous if a mechanical braking device is provided for holding the striking tool in the end position. The mechanical braking device or brake then has an effect on the flywheel, for example, when reaching the end position and holds it whereby the striking tool is also stopped in its movement.

The position measuring device preferably comprises a conventional and particularly contactless position sensor, particularly an optical, magnetic, or inductive and preferably incremental position sensor. The invention is further explained in the following by means of examples and under reference to the enclosed drawings.

The respective representations depict:

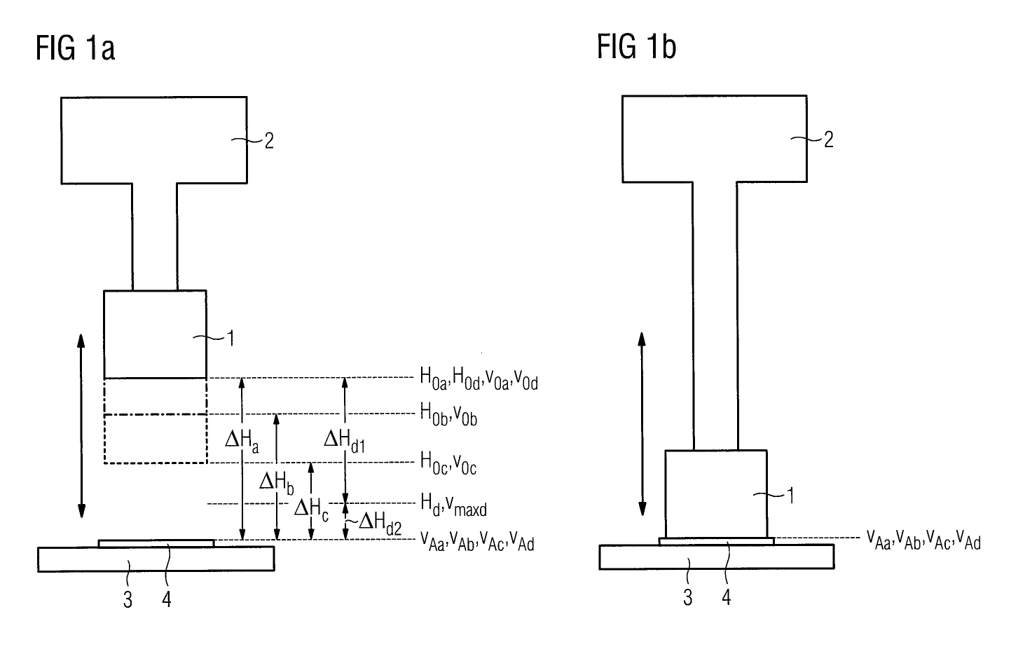

FIG. 1a a simplified representation of an embodiment of carrying out the method in accordance with the invention;

FIG. 1b the method in accordance with FIG. 1a after a completed striking movement;

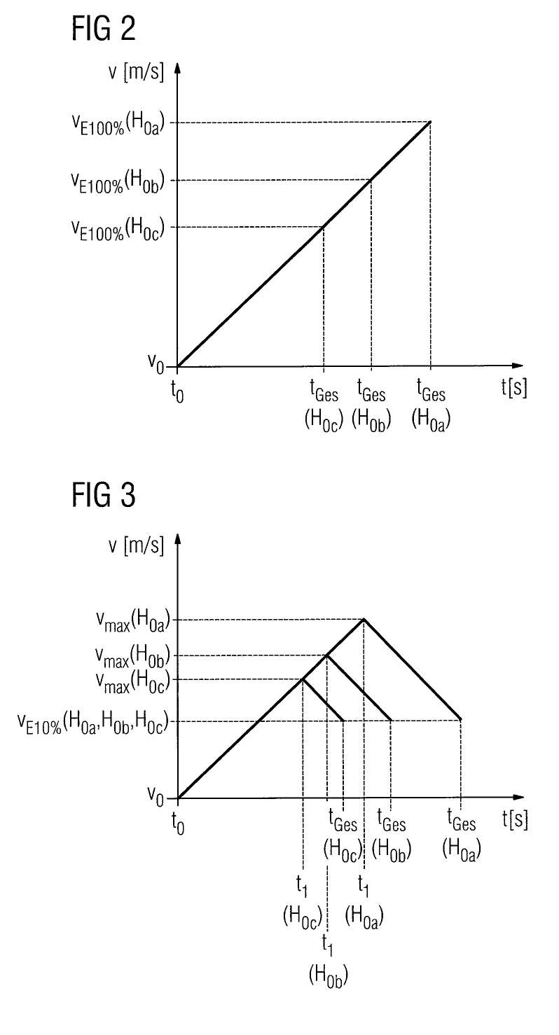

FIG. 2 illustrates a velocity-time diagram, which depicts theoretical velocity-time courses or runs at constant starting acceleration;

FIG. 3 a velocity-time diagram, which depicts theoretical velocity-time courses or runs at constant starting acceleration and following constant deceleration for a constant impact velocity from different initial positions;

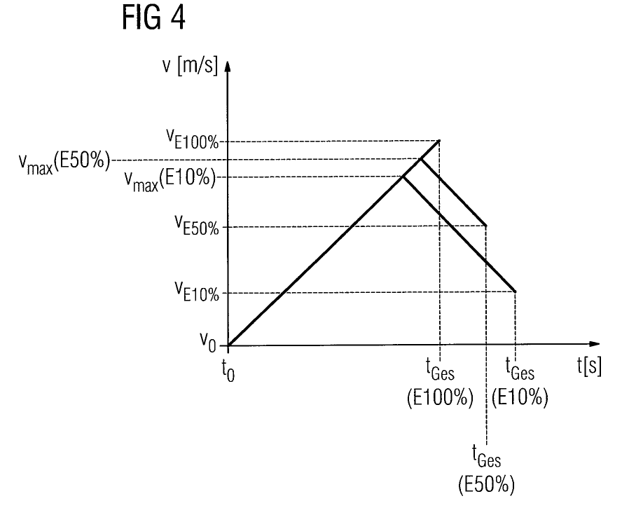

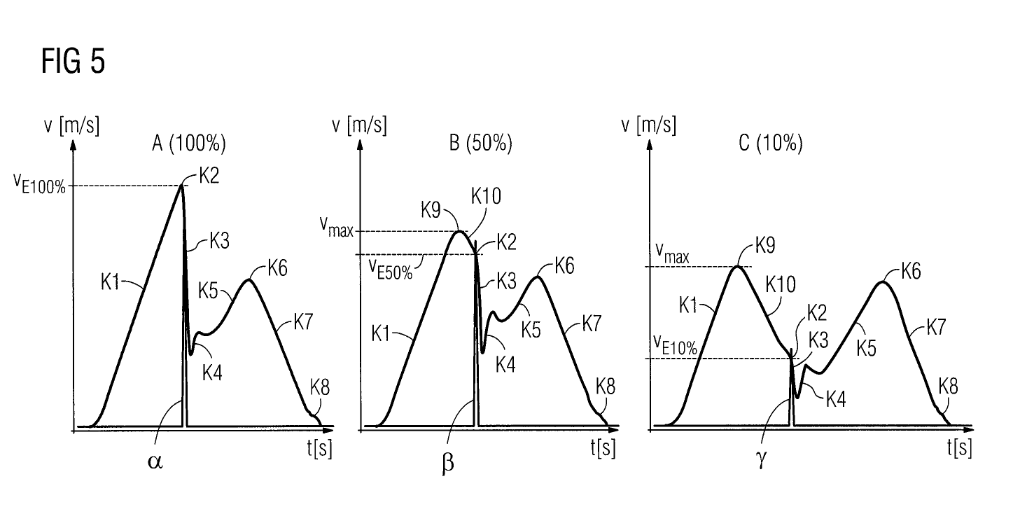

FIG. 4 a velocity-time diagram, which depicts theoretical velocity-time courses or runs for reaching different impact velocities from a constant initial position;

FIG. 5 a velocity-time diagram, which depicts real, measured velocity-time courses or runs of the method in accordance with the invention;

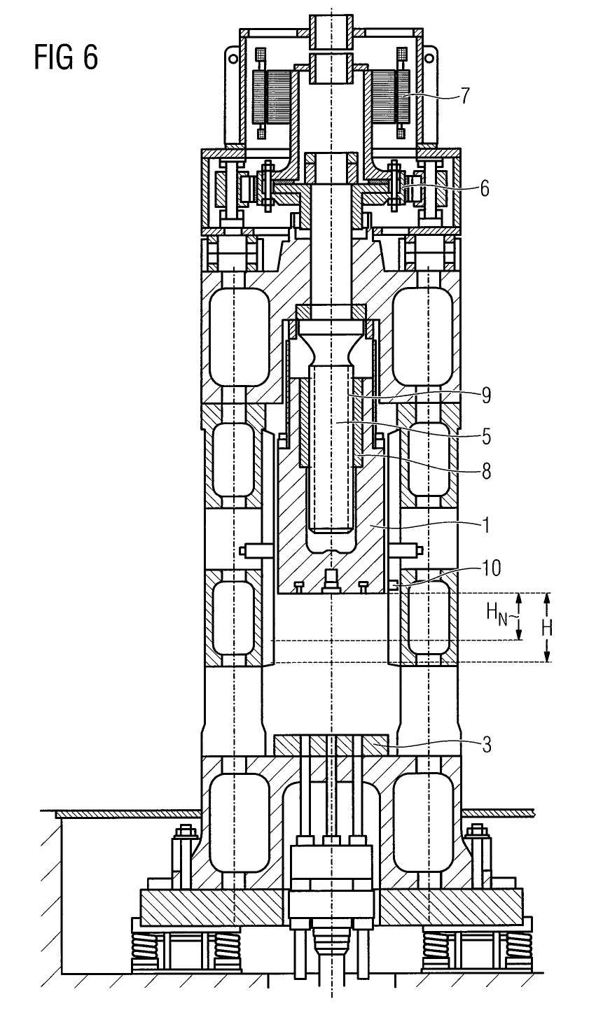

FIG. 6 an advantageous embodiment of a shaping device for the execution of the method in accordance with the invention. Parts and sizes corresponding to each other are put the same reference signs into the FIG. 1 to 6.

### CARRYING OUT OF THE METHOD IN ACCORDANCE WITH THE INVENTION

The method of shaping is greatly simplified in FIG. 1a and FIG. 1b represented in accordance with the invention. FIG. 1a and FIG. 1b show a simple shaping device to the illustration with a striking tool, particularly a ram 1, drive device 2 and a support 3 on which a workpiece 4 is disposed. The position of the ram (not represented here, cf. FIG. 6) is determined with a position determiner or sensor. The ram 1 is accelerated by a drive device from an initial position H₀ₐ, H_{0b}, H_{0c}, H_{0d} (H₀ₐ=H_{0d}>H_{0b}>H_{0c}) (FIG. 1a). The initial velocities of the ram, v₀ₐ, v_{0b}, v_{0c}, v_{0d} are 0 m/s, in all accompanying initial positions H₀ₐ, H_{0b}, H_{0c}, H_{0d}. The ram 1 moves downwardly upon the support 3. When the ram 1 has impacted the workpiece 4, it has reached an impact velocity V_{Aa}, V_{Ab}>V_{Ac}, V_{Ad} (FIG. 1b).

The initial position H₀ₐ, H_{0b}, H_{0c}, H_{0d} of the ram 1 can be adjusted arbitrarily. Therefore, by way of example, two differently sized (e.g. heights) workpieces could also be processed with the same impact velocity VA, which results from the same working stroke ΔH or by accelerating H₀ₐ, H_{0b}, H_{0c}, H_{0d} from the different initial positions under the different impact velocities V_{Aa}, V_{Ab}, V_{Ac}, V_{Ad} are reached. The maximal working stroke ΔHₐ, is reached from the initial position H₀ₐ and achieved is the maximum shaping energy at a continuous acceleration to a maximum impact velocity V_{Aa}. Arbitrarily lower initial positions, H_{0c}, H_{0d} can be set. The lower the chosen initial position the lower the at maximal attainable impact velocity (V_{Ab}>V_{Ac}) with continuous acceleration.

It is also possible with the method according to the invention to first accelerate the ram 1 in direction of the workpiece 4 from an initial position H_{0d}, and after a pre-selected partial work stroke ΔH in a pre-selected height or position H_{d5} both for a subsequent position and for a braking position, to brake for a second pre-selected partial work stroke ΔH_{d2} so that an impact velocity vA_{d} is set with respect to the shaping energy that results, which is smaller than that which is possible to achieve from the initial position H_{0d}.

The ram 1 can advantageously be constantly initially accelerated constantly, and brakingly decelerated with respectively different amounts of the acceleration. The method is not restricted, however, to this variant since initial acceleration and braking acceleration do not have to be constant.

In FIG. 1a, the partial working strokes ΔH_{d1} and ΔH_{d2} as well as the braking position H_{d} between initial accelerations and braking procedure only from the maximum initial position (H₀ₐ=H_{0d}) are represented. However, the ram 1 can be at first accelerated also from all other initial positions (H_{0b}, H_{0c}=H_{0d}) and braked as of a pre-determined position normally to the different position, H_{d} as depicted in FIG. 1 a.

When a lot of space must be available below the ram if big or long workpieces must be put into the shaping device, a velocity run or course with initial accelerations and braking procedure is of advantage in an embodiment. The ram 1 for example is then driven from the maximum initial position H₀ₐ=H_{0d}, and after inserting the workpiece 4, the ram 1 is first accelerated and then braked to the desired impact velocity v_{Ad}. If flat workpieces 4 are processed, the impact velocity V_{Aa}, V_{Ab}, V_{Ac} as a rule is simply raised by accelerating from the respectively necessary initial position H₀ₐ, H_{0b}, H_{0c}.

The velocity course or run of the ram stroke, as well as the working stroke and the return stroke, is determined by a control device that advantageously includes a microprocessor device in a frequency controlling unit (here not depicted) that is included in the driving direction 2.

Therein, at least the initial position H₀ₐ, H_{0b}, H_{0c}, H_{0d} and the desired impact velocities V_{Aa}, V_{Ab}, V_{Ac}, V_{Ad} are defaults. Furthermore the amount of the initial or starting acceleration and the braking acceleration can be provided or be predefined or preset. The control device then calculates the stroke course or run with respect to the height of the working stroke or partial working stroke ΔHₐ, ΔH_{b}, ΔH_{c}, ΔH_{d1} and ΔH_{d2}, so that for reaching the desired impact velocity V_{Aa}, V_{Ab}, V_{Ac} V_{Ad} at the predefined values for the initial acceleration and the braking acceleration, if possible the shortest stroke time results, altogether. The result can be a continuous stroke course or run with a continuous initial acceleration, or the control device determines a braking position H_{d}, for the ram 1 for braking until impact.

The return stroke is indicated nominally by the arrow in FIGS. 1a and 1b. After the impact on the workpiece 4 the ram 1 is drawn back by use of a drive device 2 and returned to the initial position again, H₀ₐ, H_{0b}, H_{0c}, H_{0d}, or returned to an arbitrary other stopping position. At first the ram 1 is accelerated and also braked in a position H_{d} determined by the control device so that the velocity approaches 0 m/s at the stop position. The position H_{d} as of which the ram 1 is braked is depending on the desired stop position and perhaps also of the recoil of the ram 1.

FIG. 2 shows theoretical velocity-time courses or runs with a constant initial or starting acceleration from different initial positions H₀ₐ, H_{0b}, H_{0c}. The ram is accelerated at constant initial acceleration from the initial position H₀ₐ, H_{0b}, H_{0c} to the maximum impact velocity V_{Aa}, V_{Ab}>V_{Ac} for a maximum shaping energy (100%). This maximum impact velocity V_{Aa}, V_{Ab}, V_{Ac} is marked in the diagram by V_{E100}% (H₀ₐ), V_{E100}% (H_{0b}), V_{E100}% (H_{0c}). The time duration until the maximum impact velocity V_{E100}% is reached, corresponds to the total duration of time of the working stroke t_{Ges} from the respective initial position H₀ₐ, H_{0b}, H_{0c} in which to is always 0 s. From the diagram it is seen that from different initial starting positions H₀ₐ, H_{0b}, H_{0c} different high maximum impact velocities V_{E100}% (H₀ₐ), V_{E100}% (H_{0b}), V_{E100}% (H_{0c}) can be achieved, and indeed, the higher the initial position, the higher the impact velocity. The total time of the working stroke t_{Ges} prolongs itself with an increasing initial position H₀ₐ, H_{0b}, H_{0c}.

FIG. 3 shows theoretical velocity-time courses or runs at constant initial acceleration and subsequent constant braking for a constant impact velocity. Therefore, the same initial positions H₀ₐ, H_{0b}, H_{0c} such as in FIG. 2 achieve a constant impact velocity V_{A}, as in the case of FIG. 2 from which for example only 10% of the maximum shaping energy results, i.e. V_{A} is equal to V_{E10}%, (H₀ₐ, H_{0b}, H_{0c}). With known constant initial acceleration and braking acceleration, known impact velocity and known initial position and using the dynamic equations for every initial position the total time of the working stroke t_{Ges}, and the working stroke time t₁ or the stopping position at which the braking procedure must be carried out, can be determined. The result of such an idealized velocity-time course or progression is represented in FIG. 3, The maximum velocities vₘₐₓ (H₀ₐ), vₘₐₓ (H_{0b}), vₘₐₓ (H_{0c}), are reached after the working stroke times t₁, (H₀ₐ), t₁ (H_{0b}), t₁ (H_{0c}). The ram is braked with the braking acceleration, and after the duration of the working stroke t_{Ges} (H₀ₐ), t_{Ges} (H_{0b}), t_{Ges} (H_{0c}), strikes the workpiece with the velocity V_{E10}%. From FIG. 3 it is seen that the higher the initial position H₀ₐ, H_{0b}, H_{0c} is chosen, the longer is the duration of the working stroke t_{Ges} until the pre-selected impact velocity V_{E10}% is reached. Furthermore also the working stroke time t₁, (H₀ₐ), t₁ (H_{0b}), t₁ (H_{0c}) prolongs itself with an increased initial position, H₀ₐ, H_{0b}, H_{0c} until the braking procedure is started and the maximum velocity of the ram increases to vₘₐₓ (H₀ₐ), vₘₐₓ (H_{0b}), vₘₐₓ (H_{0c}).

The method in accordance with the invention made possible to produce different impact velocities from a constant initial position depending on desired results. FIG. 4 depicts three theoretical velocity-time courses or runs for reaching different impact velocities from a constant initial position. The initial position corresponds to the maximum initial position H₀ₐ. In order to achieve the maximum shaping energy that corresponds to the maximum striking velocity V_{E100}% the ram is constantly accelerated from the initial position H₀ₐ until it impacts the workpiece. The duration of this working stroke is marked in the diagram by t_{Ges} (100%). If merely an impact velocity V_{E50}% which corresponds to 50% of the maximum shaping energy shall be reached from the same initial position H₀ₐ, then the ram is accelerated on Vₘₐₓ (50%) and as from a pre-selected position with respect to time is braked to the predefined impact velocity V_{E50}%. From the diagram it is depicted that this process lasts longer (t_{ges} (50%)), from the acceleration onto 100% of the shaping energy. The third curve also shows running into an impact velocity v_{E10}%, which corresponds to nominally 10% of the maximum shaping energy, also from the initial position H₀ₐ. In this case, the maximum speed vₘₐₓ (10%) is lesser than when producing the 50% shaping energy the total duration of the working stroke t_{Ges} (10%) again is longer. The relation between shaping energy E and speed V can ideally be given as E=½ mV². The velocity V is therefore proportional to the root of E.

FIG. 5 shows three real, measured velocity time courses of the method in accordance with the invention which are comparable with the theoretical speed time courses represented in FIG. 4. The working stroke with respect to the initial position can be assumed by all curves A, B, and C as equal in size. For the shaping processes however different impact velocities were chosen with respect to different shaping energies, which are marked by 100%, 50% and 10% and assigned to the curves A, B, C, respectively. Moreover, in the velocity-time courses the impact force α, β, γ is included for the impacts of the ram upon the workpiece.

The curve A (100%) shows the velocity-time course for an acceleration to the maximum speed for reaching the maximum shaping energy. The ram is accelerated from the initial position over the curve section K1, until it reaches the maximal possible striking velocity V_{E100}% in curve section K2. The curve section K3 depicts braking the ram by the energy loss at the impact. A part of the energy is brought captured in the shaping process. The remaining energy is at least partly converted into a recoil of the ram (K4). The balance of the velocity in the curve A (100%) can be explained by this recoil.

The ram then is by means of the drive motor, as a rule, this one is driven in a controlled manner in the direction of the stop position only after the impact and recoil switched on again or reconnected. At first, the ram is accelerated up to a preselected position, as depicted in the curve section K5. When achieving the preselected position, the ram is braked by means of the motor. The curve section K6 describes this situation or the necessary time by which it is represented in this and in the following curves and the maximum speed reached at that time. After achieving the pre-selected position, the ram is braked by the drive engine until it reaches a very low velocity (K7). If the ram has arrived at the pre-selected stop position, a mechanical brake grips the ram as depicted in curve section 8. The ram is braked to exactly 0 m/s and held in the stop position. The amount of the braking acceleration is changed by gripping the mechanical brake, which appears to be a small deflection in curve K8.

The impact strength a at which the ram hits the workpiece is exactly carried out at the time. In the representation this can be seen to this that the maximum of a lies with a time shortly after reaching the desired impact velocity. This also applies to the impact strengths B and y in the wider curves.

The curve B (50%) shows the velocity-time course for an acceleration to a velocity for reaching 50% of the maximum shaping energy at constant working stroke. This means that the ram is first accelerated (K1) until a pre-selected position with a pre-selected maximum velocity vₘₐₓ is achieved (K9) and then followed by braking to the desired impact velocity V_{E50}% (K2). The reduction of the velocity during the braking process is depicted in curve section K10. In the curve section K2 the desired impact velocity V_{E50}% is then reached in turn. The further course of the curve B (50%) corresponds to the course of the curve A (100%). The ram is braked (K3) and rebounds by the impact (K4). Then the drive motor grips and controls the ram by accelerating (K5, K6) and braking (K7) into the stop position in which the mechanical brake stops the ram (K8).

The curve C (10%) shows the velocity-time course for an acceleration to a velocity for reaching 10% of the maximum shaping energy at also a constant working stroke. The path of the curve is comparable with that of B (50%). The desired impact velocity V_{E10}% is, however, lower so that at first on a lower maximum velocity vₘₐₓ than at B (50%) (K1, K9) is accelerated and must be braked over a longer time period (K10). The total time of the working stroke is insignificantly longer through this in comparison with B (50%).

A shaping device according to the invention represented is in FIG. 6 which is particularly suitable for the execution of the method in accordance with the invention. The ram 1 is driven over a spindle 5. The spindle 5 disposes a ram nut 8 fastened to the ram 1 of a steep common thread 9 in this for it runs. The spindle 5 is coupled with a flywheel 6 of a drive engine 7, as a rule one changeable asynchronous machine, direct speed more variably are driven in its direction of rotation. The flywheel 6 is set into rotation and therewith the coupled spindle 5 by use of the drive motor. The angular velocity of flywheel 6 and spindle 5 is adjusted by the speed of the drive motor 7. A frequency converter unit with a microprocessor is provided for control and regulation of the speed (not represented here). The rotation of the spindle 5 is transferred to the ram 1 over the spindle nut 8 and this moved by it toward the support 3 to or from this away. The speed of the drive motor 7 is a measure for the velocity of the ram 1.

A workpiece can be found (not represented here) on the support 3 that the ram hits with a pre-selected impact velocity. Shortly before the impact, the drive motor 7 is turned off so that the control device is protected from damage or impairment by peak voltage and peak currents which can occur at the impact. After the impact or recoil of the ram 1 the drive motor 7 is switched on again and the ram 1 is raised back into its stop position.

The position of the ram 1 is measured in a contactless manner by a magnetic incremental position sensor 10. The measurements can be transmitted to the frequency converter unit and to external control device. The measured values are used by the frequency converter unit, for example, to communicate the rotational speed with respect to the velocities of the ram, which is useful for an optimal shaping process or to reach the pre-selected final position of the ram.

All publications, patents, and patent documents are incorporated by reference herein, as though individually incorporated by reference. The invention has been described with reference to various specific and preferred embodiments and techniques. However, it should be understood that many variations and modifications may be made while remaining within the spirit and scope of the invention.

1. A method for shaping at least one workpiece (4) wherein a striking tool (1) during a striking movement from a predefined initial position (H₀ₐ, H_{0b}, H_{0c}) impacts a workpiece (4) disposed on a support (3) with a pre-selected impact velocity (v_{Aa}, v_{Ab}, v_{Ac}, v_{Ad}),
wherein the velocity of the striking tool (1) during the striking movement, is controlled in open loop or closed loop dependent upon the position of the striking tool (1) and dependent upon the pre-selected impact velocity (v_{Aa}, v_{Ab}, v_{Ac}, v_{Ad}).

2. The method according to claim 1, wherein at least one position of the striking tool (1) is measured or determined, and wherein values of the velocity during the striking movement are calculated or computed using at least one position value of the striking tool (1) and the pre-selected impact velocity (v_{Aa}, v_{Ab}, v_{Ac}, v_{Ad})

3. The method according to claim 2, wherein the position value of the striking tool (1) is communicated to a open loop or closed loop control device for open loops or closed loops control of the striking tool.

4. The method according to claim 2, wherein the initial position (H₀ₐ>H_{0b}, H_{0c}) of the striking tool (1) and/or the position thereof after a return stroke movement thereof is measured or determined.

5. The method according to claim 2, wherein the position of the striking tool (1) is measured or determined after the deformation of the workpiece (4) by the impact.

6. The method according to claim 1, wherein the striking tool (1) is accelerated to the pre-selected impact velocity (v_{Aa}, v_{Ab}, v_{Ac}) from the initial position.
(H₀ₐ, H_{0b}, H_{0c}).

7. The method according to claim 6, wherein the initial position (H_{0b}, H_{0c}) is adjusted lower than a maximum initial position (H₀ₐ) in order to reach an impact velocity (v_{Ab}, v_{Ac}) that is lower than a maximum impact velocity (V_{Aa}).

8. The method according to claim 1, wherein the striking tool (1) accelerates from the initial position (H_{0d}) and is braked when it reaches a predetermined position (H_{d}) between the initial position (H_{0d}) and the workpiece (4) in order to reach the pre-selected impact velocity (V_{Ad}).

9. The method according to claim 1, wherein the velocity of the striking tool (1) is controlled in open loop or closed loop during the striking movement so that from an arbitrary initial position (H₀ₐ, H_{0b}, H_{0c}, H_{0d}) the shortest possible working stroke time (t_{Ges}) is achieved.

10. The method according to claim 1, wherein the control of the velocity of the striking tool (1) is carried out with an open loop or closed loop control device which controls a variable-velocity drive motor (7) in a drive device (2) for the striking tool.

11. The method according to claim 10, wherein a frequency converter unit is used as control device, which controls in open loop or closed loop the rotational speed and rotational direction of the drive motor (7).

12. The method according to claim 11, wherein the frequency converter unit, in particular by means of a microprocessor, determines the run or course of the rotational velocity of the drive motor (7) during the striking movement, dependent upon a predefined impact velocity (v_{Aa}, v_{Ab}, v_{Ac}, v_{Ad}) and a pre-selected initial position (H₀ₐ, H_{0b}, H_{0c}) and/or upon a position measured or determined by means of a position measuring device.

13. The method according to claim 1, wherein after the impact, the striking tool (1) is returned to a pre-selected or pre-selectable stop position by a return stroke movement.

14. The method according to claim 13, wherein the return stroke movement to the stop position is accomplished at a reversed direction of rotation of the drive motor (7).

15. The method according to claim 13, wherein the velocity of the striking tool (1) during the return stroke movement to the stop position is controlled in open loop or closed loop dependent upon the position of the striking tool (1).

16. The method according to claim 15, wherein the open loop or closed loop control of the velocity of the striking tool (1) is carried out with the frequency converter unit, which determines the course or run of the rotational speed during return stroke movement dependent upon the pre-selected stop position and/or a position measured by the position measuring device.

17. The method according to claim 13, wherein as the stop position of the return stoke the initial position (H₀ₐ, H_{0b}, H_{0c}) of the striking tool (1) for the working stroke (ΔHₐ, ΔH_{b}, ΔH_{c}) is chosen.

18. The method according to claim 13, wherein the stop position of the return stoke is chosen dependent upon the workpiece (4) to be worked on and/or by the desired impact velocity (v_{Aa}, v_{Ab}, v_{Ac}, v_{Ad}) for the subsequent striking movement.

19. The method according to claim 13, wherein during the return stroke movement the striking tool (1) is accelerated away from the workpiece (4) or the support (3) towards the stop position, and when reaching a pre-selected position (H_{d}) between the workpiece (4) or the support (3) on the one hand, and the stop position on the other hand, is braked by the drive motor (7) in the manner of a generator.

20. The method according to claim 13, wherein the striking tool (1) is braked completely or stopped by a mechanical braking device when reaching the stop position.

21. The method according to claim 1, wherein the workpiece (4) with the striking tool (1) is traveled to the stop position and the workpiece (4) is then removed from the striking tool (1) in the stop position.

22. The method according to claim 1 one or more of the preceding claims, wherein the striking tool (1) during acceleration is accelerated with a predefined constant starting acceleration.

23. The method according to claim 1, wherein the striking tool (1) during braking is braked with a pre-selected constant braking acceleration.

24. The method according to claim 10, wherein before the impact of the striking tool (1) on the workpiece (4), the drive motor (7) becomes switched without momentum and/or disengaged within the drive device (2).

25. The method according to claim 1, wherein during braking the striking tool (1) by means of the drive motor (7), the drive motor (7) is operated as a generator.
